(19) United States
(12) Patent Application Publication
(10) Pub. No.: US 2014/0004483 A1
(43) Pub. Date: Jan. 2, 2014

(54) Personal Lifecycle Engine

(71) Applicant: Kerry John Enright, Mira Loma, CA (US)

(72) Inventor: Kerry John Enright, Mira Loma, CA (US)

(21) Appl. No.: 13/708,044

(22) Filed: Dec. 7, 2012

Related U.S. Application Data
(63) Continuation of application No. 13/541,556, filed on Jul. 3, 2012.
(60) Provisional application No. 61/576,202, filed on Dec. 15, 2011.

(51) Int. Cl. G09B 5/00; G09B 19/00

(52) U.S. Cl. CPC G09B 5/00; G09B 19/0092
USPC 434/127; 434/247

(57) ABSTRACT

The Personal Lifecycle Engine is a set of methods and systems based on the Ten-Level Enterprise Architecture designed to empower personal wellness and health. The Engine, unlike institution-provided solutions, provides person-centricity providing the user with life-long personal control of wellness and health information. The Engine is scenario centric and personal aspiration driven employing personally designed daily wellness and health activities as executable and measurable processes.

The Personal Lifecycle Engine serves the user by controlling the input and output of information. It controls the disclosure of private information to the specific wellness and health need. It designs healthcare processes for personalized treatment and captures actual treatment processes and tracks dosages.

The Personal Lifecycle Engine employs the tightly-coupled Ten-Level Enterprise Architecture to ensure the seamless, complete and correct execution of all process logic.

### CROSS-REFERENCE TO RELATED APPLICATIONS

This application is a non-provisional application for the provisional U.S. application No. 61/576,202 filed 15 Dec. 2011 and represents a continuation in process for U.S. application Ser. No. 13/541,556 filed 7 Jul. 2012 entitled “TEN-LEVEL ENTERPRISE ARCHIECTURE”.

### BACKGROUND OF THE INVENTION

1. Field of the Invention

The disclosed technology relates to a methods and systems of guiding persons to manage their personal wellness and health.

2. Description of the Related Technology

The challenges of meeting rising demand for solutions to the cost, quantity and quality of healthcare has led to a large number of responses by both private and public institutions. These responses, though varied in content, are highly similar in approach by including a number of common elements.

The first element is that they normally start with from healthcare. The industry participants, whether government, hospitals or service providers view the primary

### SUMMARY OF CERTAIN INVENTIVE ASPECTS

The Personal Lifecycle Engine provides individuals with the methods and systems necessary to manage their wellness and health. The basic philosophy of the invention includes the following:
Healthcare is just a means to support health
Health is just a means to enable people to live their lives
Wellness is a primary determinant of health
Wellness derives from aligning the person's long term aspirations to daily life

The Personal Lifecycle Engine embodies this philosophy by enabling persons to drive their personalized wellness and health scenarios on a daily basis using the underlying technology of the Ten-Level Enterprise Architecture disclosed in U.S. application Ser. No. 13/541,556 filed 7 Jul. 2012.

The Personal Lifecycle Engine includes two major functions—the management of wellness and health through daily scenarios and the ability to transmit personal health and wellness information under security controlled conditions. These methods and systems in both their individual elements and their totality provide personal wellness and health management heretofore unavailable.

The Personal Lifecycle Engine allows the creation of daily wellness and health scenarios based on personal aspirations. The starting point of the creation is for the user to provide problem as access to healthcare and therefore push various forms of healthcare to improve health. Related to the healthcare centric approach is that the solutions are pushed from the institution to the individual in what in marketing terms is called ‘product out’. The basic operational mode is that the institution pushes the solution to the individual.

A third element of the current healthcare approach is that it tends to be episodic. When the individual goes to a physician or a medical center for examination or treatment, the amelioration is delivered based on that episode and the data reflects that event. This approach generally lacks continuity in serving the health and wellness of the individual.

Finally, current solutions depend heavily on data, but a person's data is held by institution, not by the individual. Some medical associations in fact lobby the government to prevent the person from having access to her own health records.

In contrast to this approach, studies such as the Blue Zone studies as reported in National Geographic magazine have illustrated that the people who are the longest living and face the fewest chronic conditions until the very end are typically people who have little or no access to healthcare. Clearly there is something out of missing in the current approaches. The thrust of the invention described below is to address this disparity of results with methods and systems that enable anyone to have easy access to what really works. a name that has a high probability of being unique across the human population. This uniqueness minimizes ambiguity and probability of execution error. The next part of the scenario creation enables the person to describe their future aspirations over time or their age and associate a specific image that reminds them of that aspiration. For example, if a future aspiration is to dance with one's granddaughter on her wedding day, then the aspiration image can be her photo.

For a person to achieve future aspirations he needs to have the appropriate mental and physical wellbeing and health and the creation function leads them to achieve that end. The subsequent step guides the person to select wellness criteria that raise the probability of achieving the future aspiration. Individuals are asked to specifically choose from the major elements that contribute to wellness. These include:
Religious rituals
Family rituals
Social rituals
Emotional practices
Mental practices and
Rest practices

Under each element heading, individuals are provided examples of practices that they can select from or they can employ a search engine to pull additional examples for their selection.

Health, greatly influenced by wellness, comes next. The users are offered choices of diet practices and/or menus based on health benefits, physical activity practices, medication needs and a selection of treatment options. In real life, diet and exercise tend to provide greater respite to chronic conditions than medication and treatment. At the same time, diets do not work; neither do structured exercise since they are not woven into the fabric on on-going life. What has proven to work is the activity of daily life where dietary habits and physical activity are embedded into the daily fabric of living. That is why the daily scenario is vital to success.

Once the wellness and health selection are complete, individuals can construct their daily scenarios. First they create a name for a scenario and assign one of their aspirations and its image to the scenario. Second, they define the type of day—week day, weekend, a specific calendar date or a moving event, e.g., Thanksgiving—that the scenario applies to. They then select wellness and health activities to that day by time or sequence within the day. Finally they choose where they want their scenario displayed such as a computer, phone or tablet.

When their scenarios are complete, their scenarios assigned to a type of day will be displayed—with their aspirations and images—on the user's device of choice where the user can select one. The Personal Lifecycle Engine will display the daily elements of the scenario to follow and may even run a search engine to pull in the most current information on an element.

As the user goes through the day, they can provide input either manually or through systems and devices to track progress towards the elements. This is measured against the sequence and timing to show the progress. If the user stays current with the objectives of the day, the image of the aspiration will remain clear and bright on the user's selected display. If however the user falls behind, the Personal Lifecycle Engine will fade or distort the image as time progresses. If the user catches up on the scenario, the image returns.

One final feature provides a control over more than a single day. The Personal Lifecycle Engine can keep track of cumulative exposures or dosages the user has experienced and store control limits. For example, every time the user goes for radiation, the Engine can be updated by manual or automatic means to add to the exposure count. If the user exceeds a level of safe dosage, a warning can be displayed. Additionally, infrequent needs can be tracked. For example, most people forget when they had their last tetanus shot so the Engine can provide reminders after the appropriate number of years.

The security of personal wellness and health information is crucial, but normally safeguards are out of the individual's control. The Personal Lifecycle Engine provides a set of functions to control the dissemination of the individual's confidential information. The first function is the segregation of the person's name from their unique identifier. This means that unless the Personal Lifecycle Engine explicitly attaches the individual's name to a valid transaction, there is no means by which to associate the personal records with their name. This function shields their information from unwanted disclosure.

The second control function is to validate requests for personal information. The Engine provides a list of usage id's for types of inquiries and checks the request against that list. The second check is for the user id to determine if the user has a valid need for that usage. For example, some information may be appropriate to send to a physician for a specific usage, but not to the receptionist at her office. Even a valid person such as a physician should have certain information restricted limited by the specific usage. A dermatologist may not have any need to know of one's mental health information.

Finally, the Engine checks for the condition of whether to provide the person's name or not. If the person chooses to participate in a clinical drug trial, it may not be appropriate to send their name, but only their unique identifier. In other cases, the on duty physician in the emergency room may require immediate access to the person's name. In all cases, the Engine will maintain a record of the disclosers of the personal information and the content.

### BRIEF DESCRIPTION OF THE DRAWINGS

FIG. 1:

A block diagram view of the 100 Personal Lifecycle Engine architecture and components

FIG. 2:

A functional view of the 100 Personal Lifecycle Engine and its first level sub-engines

FIG. 3:

A functional view of the 100.201 Scenario Engine

FIG. 4:

A functional view of the 100.201.301 Creation Engine

FIG. 5:

A functional view of the 100.201.301.401 Naming Engine

FIG. 6:

A functional view of the 100.201.301.401.501 PIN Engine

FIG. 7:

A functional view of the 100.201.301.402 Aspiration Engine

FIG. 8:

A functional view of the 100.201.301.403 Wellness Engine

FIG. 9:

A functional view of the 100.201.301.404 Health Engine

FIG. 10:

A functional view of the 100.201.301.405 Build Engine

FIG. 11:

A functional view of the 100.201.302 Execution Engine

FIG. 12:

A functional view of the 100.201.302.401 Activity Engine

FIG. 13:

A functional view of the 100.201.302.402 Monitor Engine

FIG. 14:

A functional view of the 100.202 Input Control Engine

FIG. 15:

A functional view of the 100.202.301 Element Engine

FIG. 16:

A functional view of the 100.202.301.401 Search Engine

FIG. 17:

A functional view of the 100.202.302 Process Engine

FIG. 18:

A functional view of the 100.203 Output Control Engine

FIG. 19:

A functional view of the 100.203.301 Create Engine

FIG. 20:

A functional view of the 100.203.301.401 Process Engine

FIG. 21:

A functional view of the 100.203.301.402 Align Engine

FIG. 22:

A functional view of the 100.203.302 Execute Engine

### DETAILED DESCRIPTION OF CERTAIN INVENTIVE EMBODIMENTS

Overview

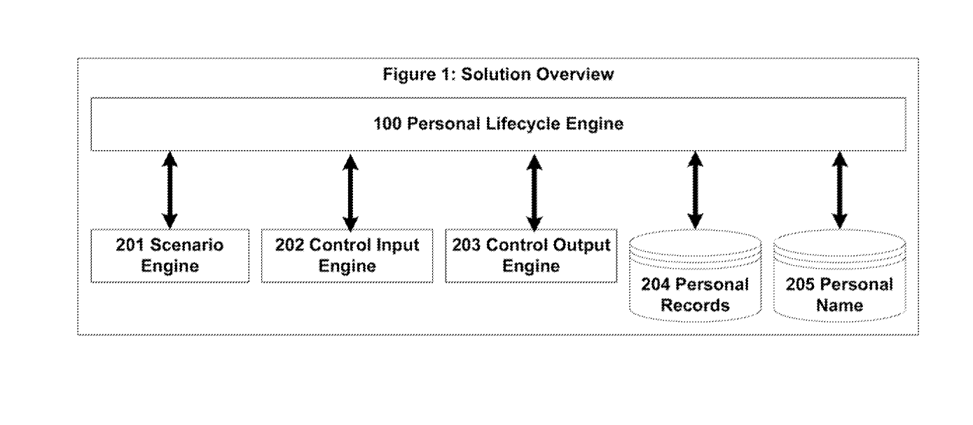

The Personal Lifecycle Engine was invented to provide a set of methods and systems heretofore unavailable to promote individual wellness and health through the exercise of daily scenarios. These methods and systems enable individuals to create a seamless linkage between their personal future aspirations and the types of daily activities that drive wellness and health that enable those aspirations to be possible. It guides the input of information into the scenario in a controlled and consistent fashion and manages the output of personal information to more individualized and accurate healthcare treatment while maintaining optimum security. The Personal Lifecycle Engine therefore provides three major functions—the management of wellness and health through personal daily scenarios and the controlled input into personal scenarios and the managed dissemination of personal information to external sources as shown in FIG. 1.

In FIG. 1, the 100 Personal Lifecycle Engine coordinates the needs of the subordinate engines and storage elements—the 201 Scenario Engine, the 202 Input Control Engine, the 203 Output Control Engine, the 204 Personal Records data storage and the 205 Personal Name data storage. The 201 Scenario Engine drives the creation and execution of daily personal wellness and health scenarios. The 202 Input Control Engine both accepts and seeks inputs for the 201 Scenario Engine in a process controlled manner. The

202 Input Control

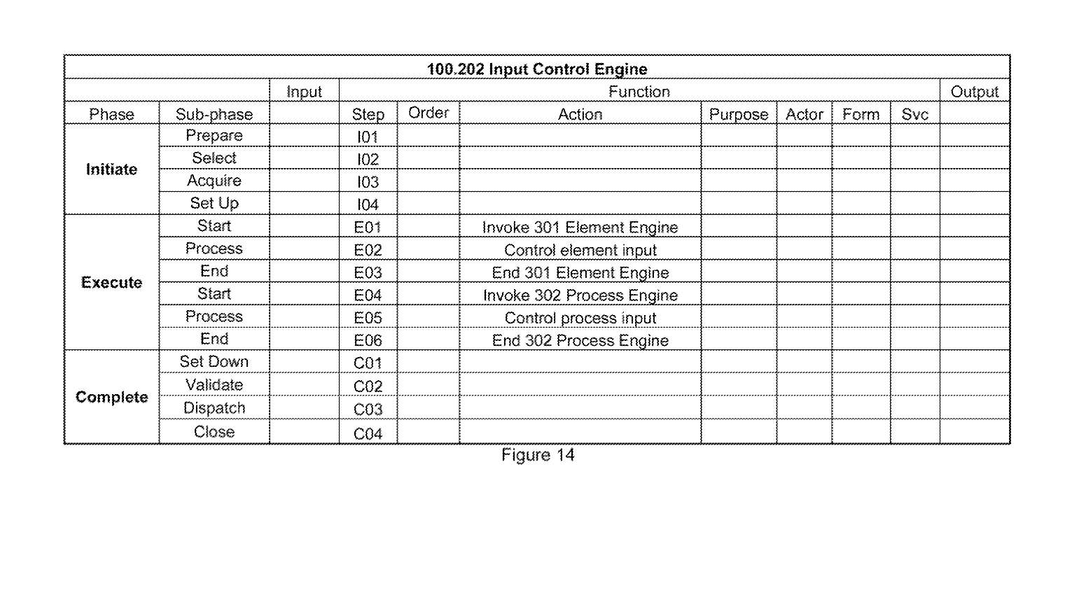

The second major function of the Personal Lifecycle Engine is the 202 Input Control Engine show in FIG. 14. The Input Control Engine provides the means to input static and process data to be entered at the appropriate place in the Personal Lifecycle Engine in a common and predictable fashion. The 202 Input Control Engine comprises two sub-engines—the 301 Element Engine and the 302 Process Engine for importing static element and process flows respectively.

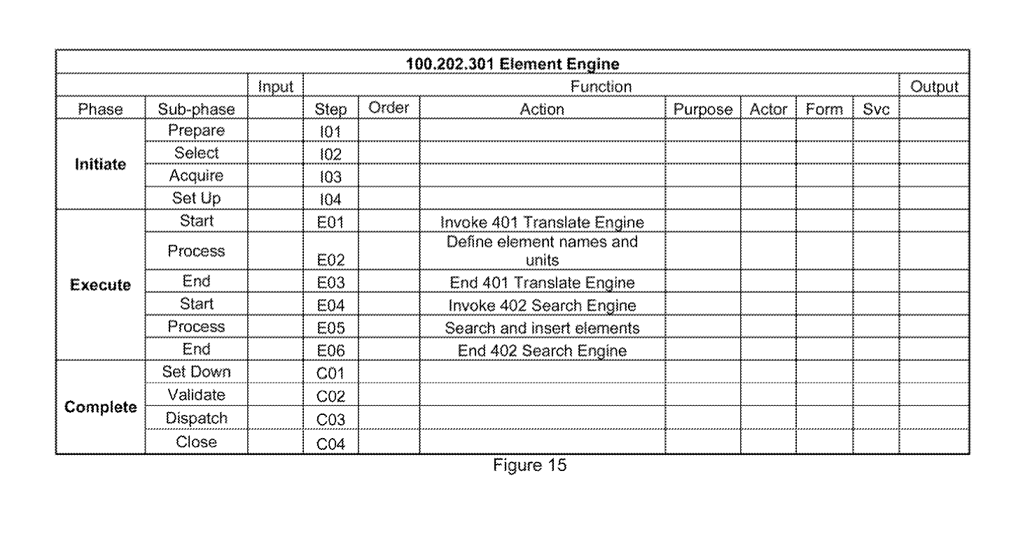

FIG. 15 shows the functions of the 301 Element Engine that captures static elements for import into the personal scenarios. The 401 Translate Engine of the 301 Element Engine creates common names for elements to be used in the scenarios to ensure accurate and consistent execution. The 501 Name Engine provides the standardized name to be used for an element in a scenario while the 502 Alternate Engine provides a translation table for alternate names used to describe the standardized name. The 503 Unit Engine provides common units for the named elements comprising weights, dimensions, volumes and other measurements to ensure consistent usage throughout the scenarios. The Unit Engine calculates alternate units into the designated standardized units.

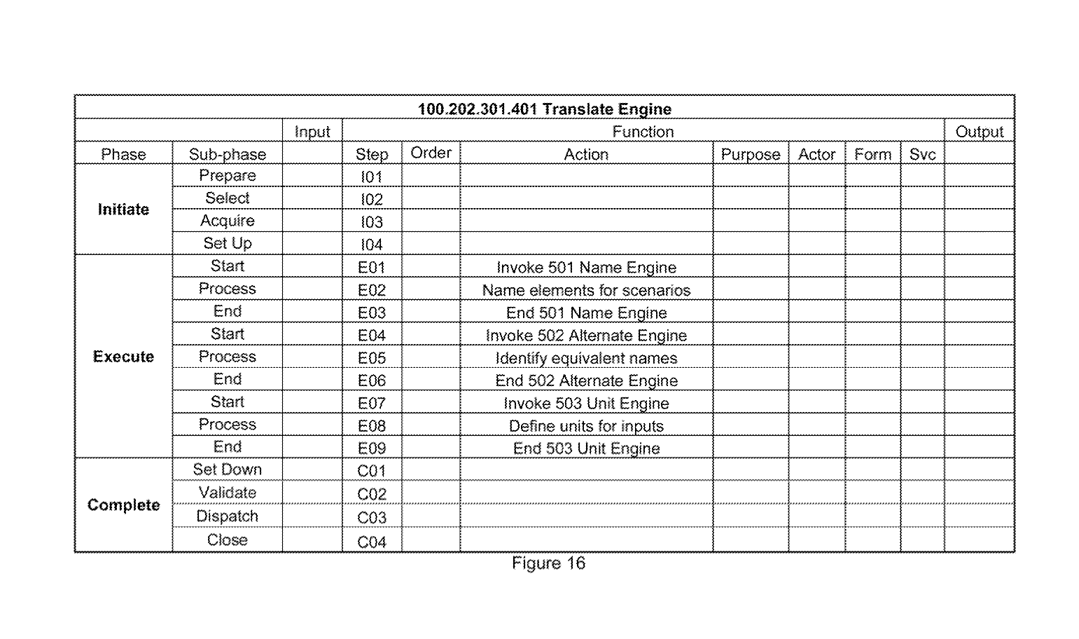

The 301 Element Engine can employ the 402 Search Engine, FIG. 16, to find the named elements in external sources using the translation table. The 501 Fetch Engine finds and 203 Output Control Engine controls the output of personal information from the 201 Scenario Engine, the 204 Personal Records data storage or the 205 Personal Name data storage system. The Personal Lifecycle Engine balances the need for information with the need for privacy. The 204 Personal Records stores all a person's scenarios and wellness and health history while the 205 Personal Name stores the personal name separately.

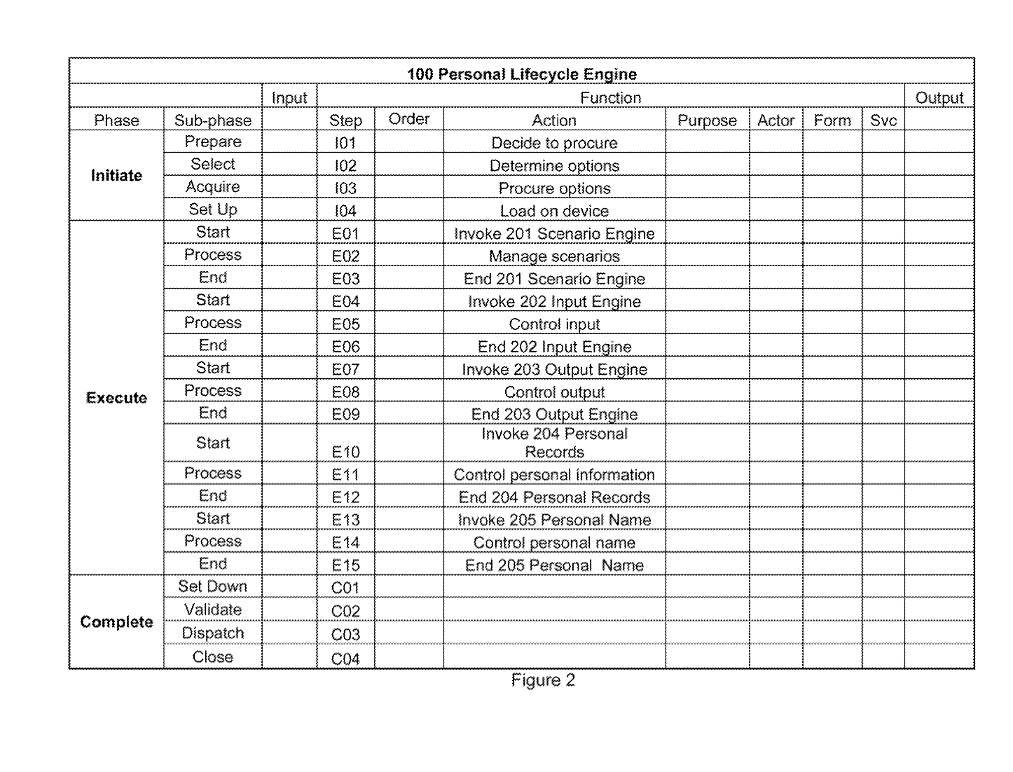

FIG. 2 shows how the 100 Personal Lifecycle Engine utilizes the structure of the Ten-Level Enterprise Architecture per U.S. patent application Ser. No. 13/541,556. The engine structure of the 100 Personal Lifecycle Engine invokes and ends the processing of each of the sub-engines to execute the scenarios or the scenarios' supporting functions. Each of these processes and sub-processes are controlled and identified using the tightly coupled hierarchical structure of the Ten-Level Enterprise Architecture. Every process on any of the engines establishes a job id with a date/time stamp that allows precise traceability of all 100 Personal Lifecycle Engine activities. Note that the blank spaces in the subsequent models denote areas of individualized content.

201 Scenario Engine: 301 Creation Engine

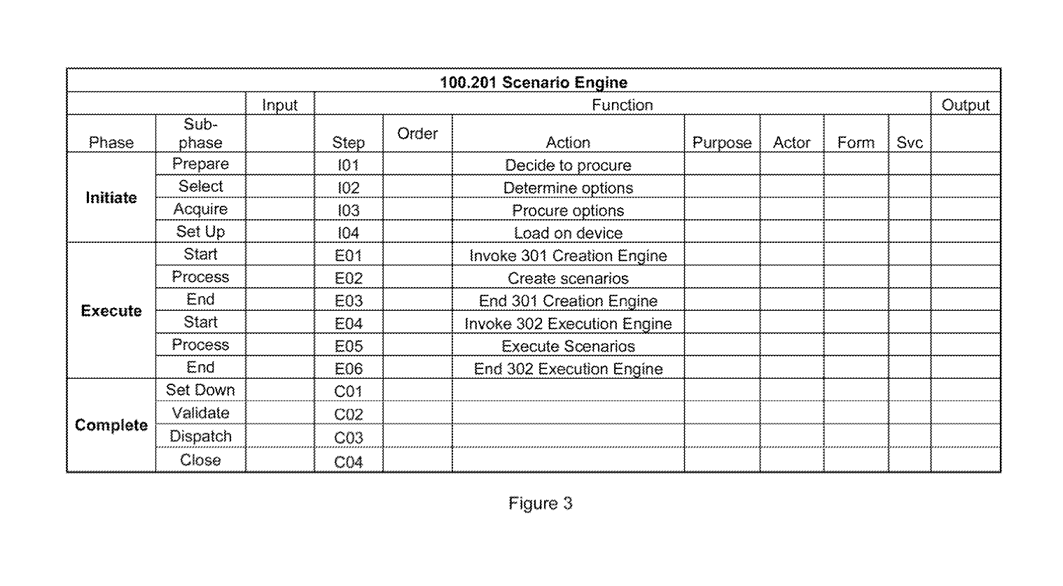

FIG. 3 shows that the 201 Scenario Engine comprises two sub-engines—the 301 Creation Engine designed to allow persons to build their daily scenarios and the 302 Execution Engine which executes the scenarios. When persons access the 100 Personal Lifecycle Engine, they can select the option of creating scenarios which directs them to the 301 Creation Engine. The 301 Creation Engine provides five sub-engines to support persons captures the required elements while the 502 Insert Engine places the elements with standardized name and units into the correct location in a process scenario.

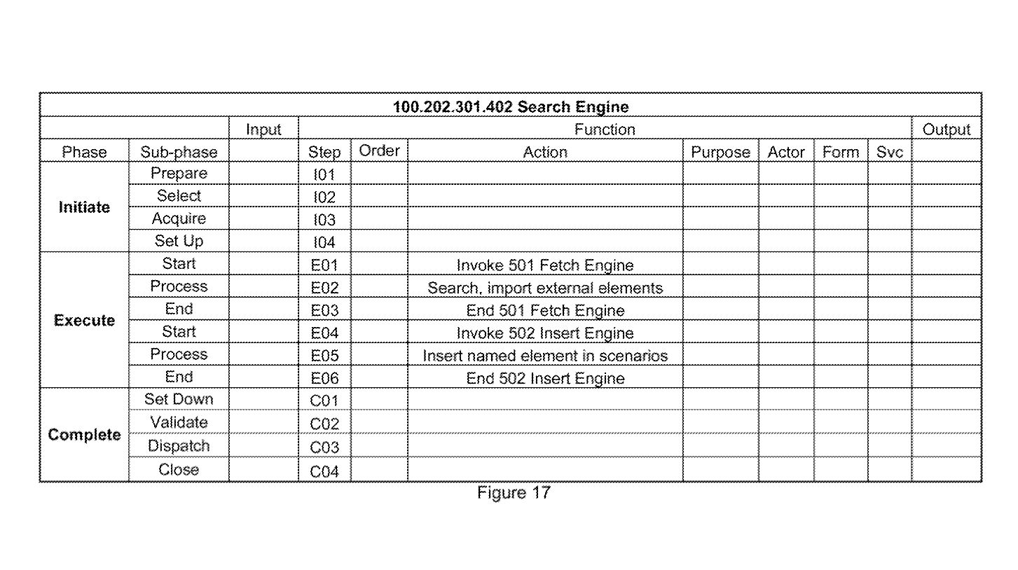

The other function of the 202 Input Control Engine is to control the input of process information using the 302 Process Engine which captures treatment process the user experiences per FIG. 17. The 401 Define Engine provides the facility to build, load and store treatment process scenarios from the time of setting an appointment through follow up care. The user, if a treatment is required, can select a scenario using the 402 Capture Engine from the scenarios stored in the 204 Personal Records and capture the treatment steps by manual or automated means as the user receives the treatment. The inputs will populate the scenario capturing the steps and the elements received during the treatment. The 403 Dosage Engine will capture the dosages of medications, radiation or other control factors that the patient receives. When the treatment is completed, the user can store the results in the 204 Personal Records.

203 Output Control Engine

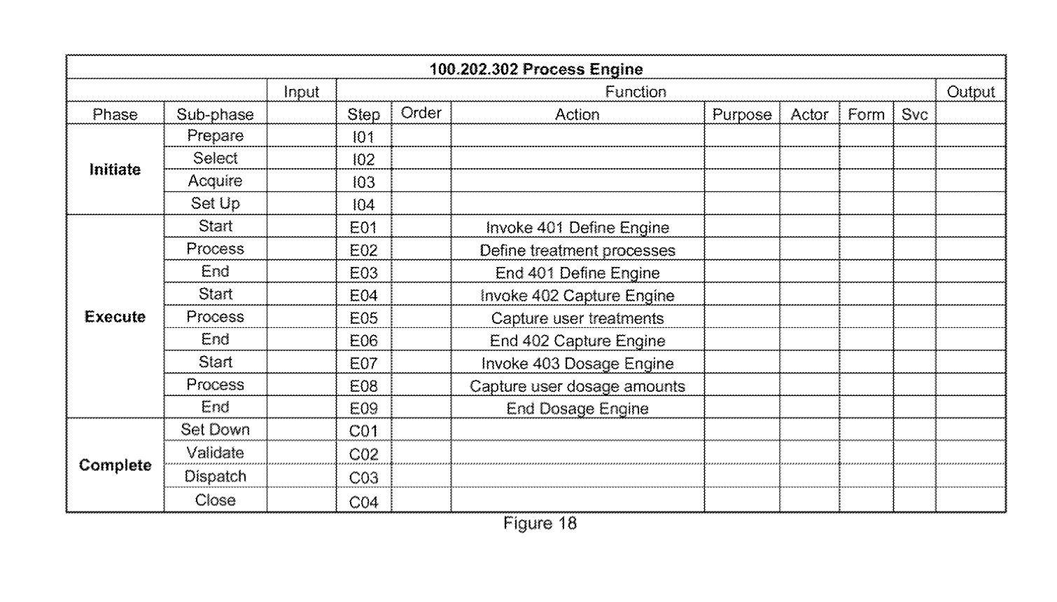

The 203 Output Control Engine per FIG. 18 provides the ability to define and execute the precise level of personal information that should be disclosed for specific types of treatment. This control serves several functions. First, it enables the user to receive targeted treatment by delivering information tailored to the treatment process. Second, segments the information in the different levels of the treatment process based on the which allows manual or automated input, provides translation tables to convert health data as follows:
Common naming for health data
Common units of measure for data
Dosage amounts for medications and radiations
Standard process format for capturing healthcare treatment
Defined locations within the user's scenario

The captured data is presented to the user in a profile.

After the data capture, the user selects an option list to attach health elements to each aspiration. Since diets do not work, the 501 Diet Engine provides a list of dietary practices—habits—that produce long term health benefits such as the consumption of nuts and grains for snacks. When the user selects the element, the engine allows the user to search external sources to discover where these items or special menus can be found. The second element is the selection of physical activities of daily live that provide continuous movement. The 502 Physical Engine offers lists that combine physical activities with wellness elements such as growing healthy vegetables in a garden. In the next step the user can add important medications followed by the inclusion of treatments. The 502 Medication Engine includes the administration of shots so that injections such as tetanus can be subject to a timer that will remind the user after several years. The 504 Treatment Engine provides schedules for check-ups and healthcare practices to remind the user or to trigger the 203 Output Engine treatment processes described below. The 202 Input need to know. Finally, it controls personal privacy by limiting the exposure of information only to the level required.

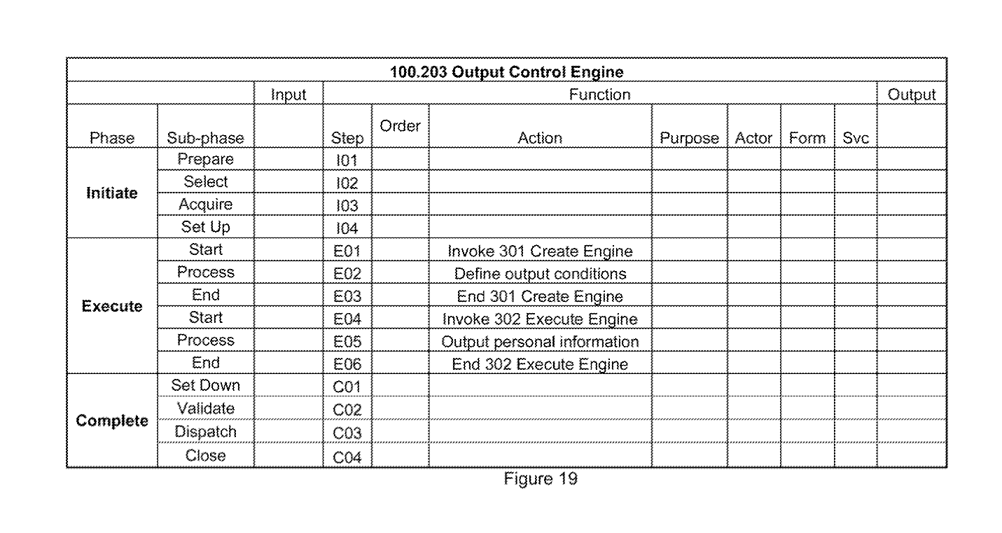

The 301 Create Engine, FIG. 19, allows the user to import, modify or create treatment processes from end to end. This can include establishing sub-processes such as appointments, registration, diagnostics, medical procedures, release and follow-up care. For each treatment process, the user can, with guidelines, choose a disclosure strategy—identifier-only or name and identifier. As an example, the identifier-only strategy allows the user to participate in clinical studies revealing intimate physiological information without the user's name being disclosed.

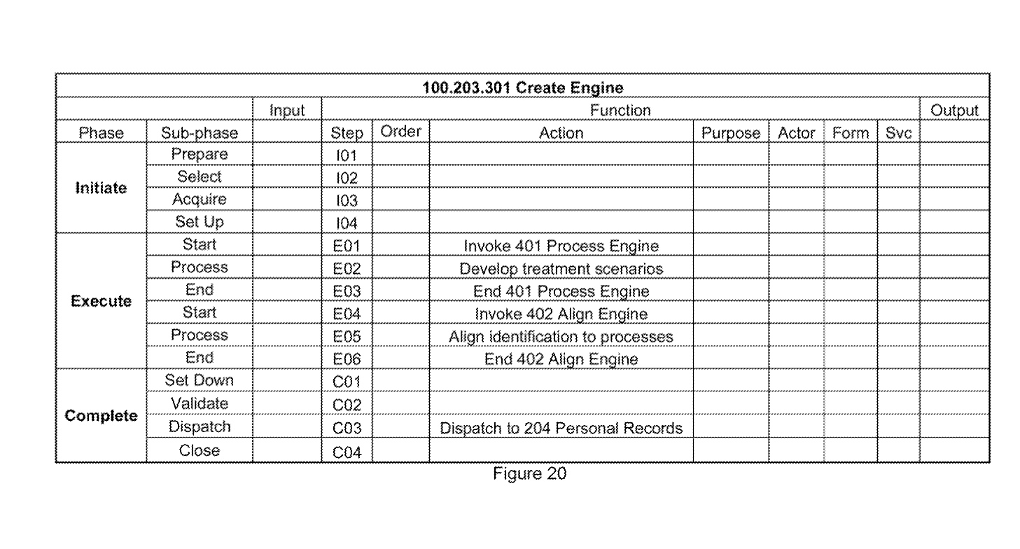

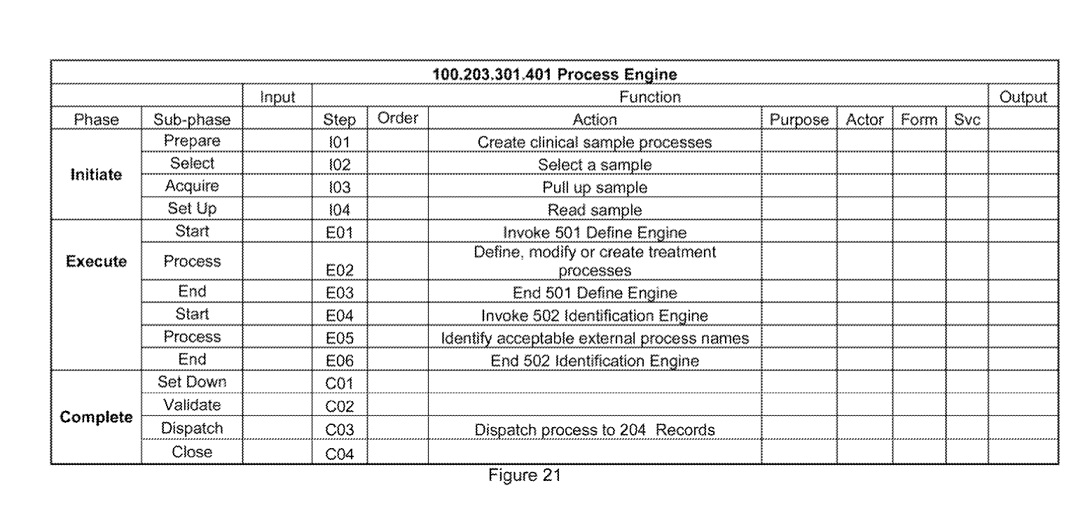

The 401 Process Engine as shown in FIG. 20 allows the user to pull up and view sample end to end treatment processes. The user can choose scenarios that they deem to be relevant and modify them as they see fit. They can even build their own treatment scenario for special needs or circumstances. When a treatment process is defined, the 402 Align Engine, FIG. 21, allows the user to align the level of disclosure to the process using the 501 Link Engine. Since a treatment process has many stages with different disclosure requirements, the user can select the level of disclosure by process stage. For example, the receptionist may need to know the patient's credit card information but not the physician. Additionally, users can choose to provide their names or omit them. For a nation-wide clinical study, users may choose to withhold their name and only provide the identifier. Users however may face unexpected emergencies and therefore they may have identifier at the top. This allows each operation within the Personal Lifecycle Engine to be uniquely identified throughout the world.

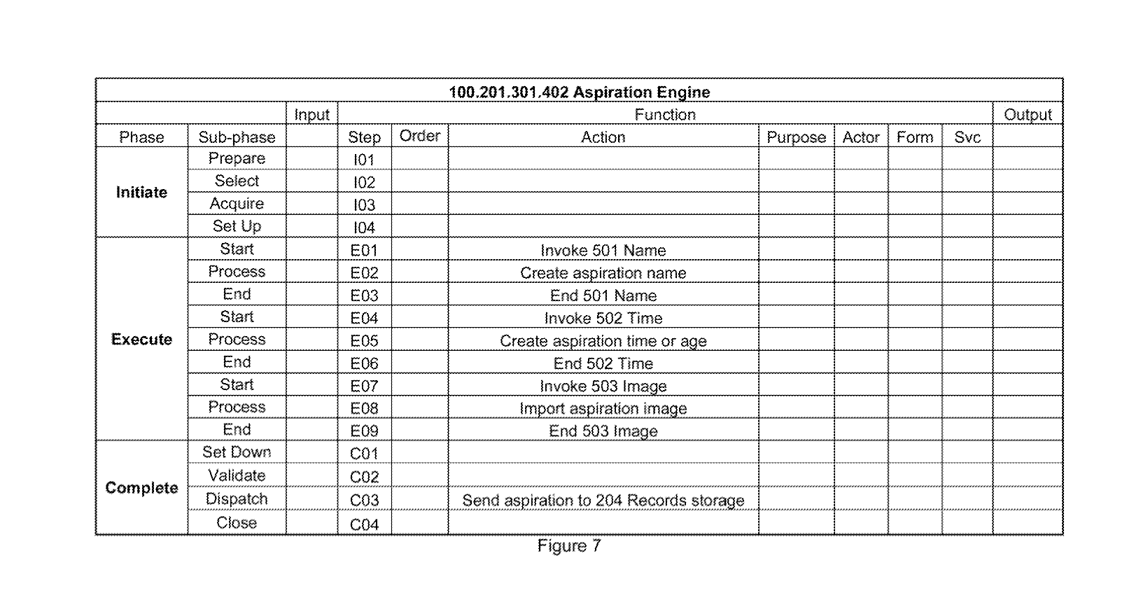

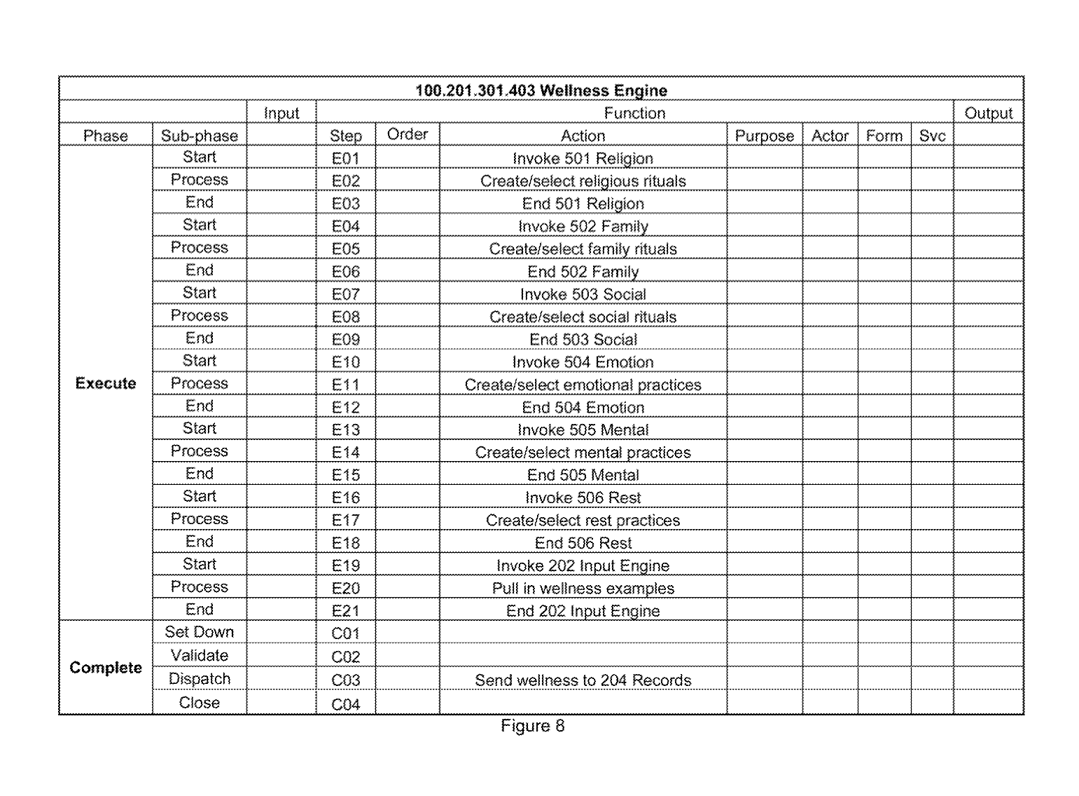

The second operation for setting up user scenarios is the capture of their future aspirations using the 402 Aspiration Engine per FIG. 7. The future can be measured in time, age or stage in life. Examples of future aspirations could include travelling to Europe in retirement, playing baseball with a grandson, dancing with a granddaughter at her wedding or being able to live in one's own home at 90 years old. The user names the aspiration per the 501 Name Engine. After the name is created, the users employ the 502 Time operation to enter their current age and specify the time of the future aspiration in either years or their age. Finally, the user is asked to provide an image to that aspiration to fix it in the user's mind using the 503 Image Engine. The image could be a picture of Europe, a picture of a grandchild or simply a picture of home. When the users have completed the aspiration definition, they store it in the 204 Personal Records.

The third operation in the creation of scenarios is the selection of wellness elements to apply to aspirations using the 403 Wellness Engine as shown in FIG. 8. Selecting the 403 Wellness Engine, the user applies wellness elements to enable the achievement of the aspiration. The Wellness Engine pulls a list out of the 204 Personal Records storage that shows different wellness elements and their relative benefits based on historical research data. Each wellness element contains preloaded examples of effective practices or activities. The 501 Religion Engine may contain, by religion, habits of worship, rituals and service. The 502 Family Engine may contain rituals around meals, walks or holiday practices; while the 503 Social Engine may contain group activities such as communal sports, visitations or discussion groups. The 504 Emotion Engine focuses on active engagement rather than passive reception. For example, instead of listening to music, it emphasizes actually singing or playing music creating a greater degree of engagement and benefit. As mental sharpness over age correlates to on-going mental activity, the 505 Mental Engine list of activities includes areas such as teaching, debating and writing. After all of these activities, the 506 Rest Engine lists good rest practices. The user of course can create their own activities to substitute those on the lists and pull in specific examples from external sources using the 202 Input Control Engine. All selections are stored in the 204 Personal Records.

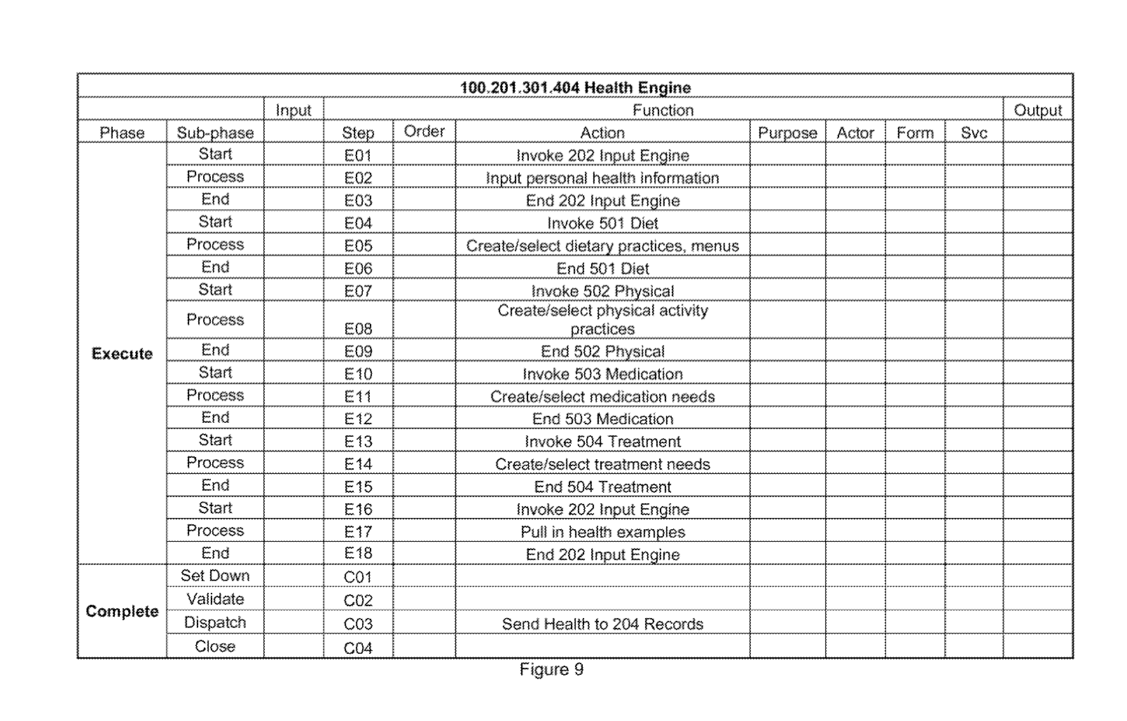

The 404 Health Engine adds health elements, per FIG. 9, to complement the wellness elements in two areas. First, as in wellness, the health elements focus on continuous activities in daily life more than episodic healthcare elements. Second, the health elements are structured to combine with the wellness elements. As an example of this, the physical activity of walking can complement the wellness family ritual by going for a family walk.

After the user selects the 404 Health Engine, the users have the option of entering their health information through the 202 Control Input Engine. The Control Input Engine, Control Engine allows users to fetch health examples from external sources. When the selections are complete, they are loaded into the 204 Personal Records.

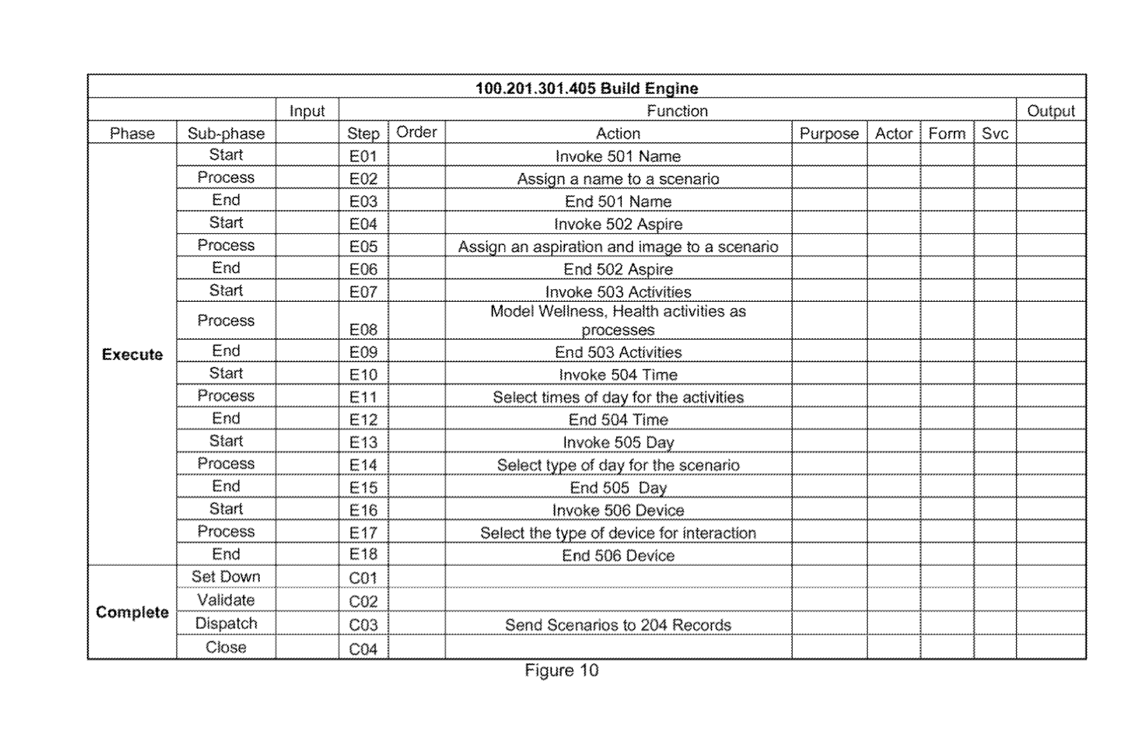

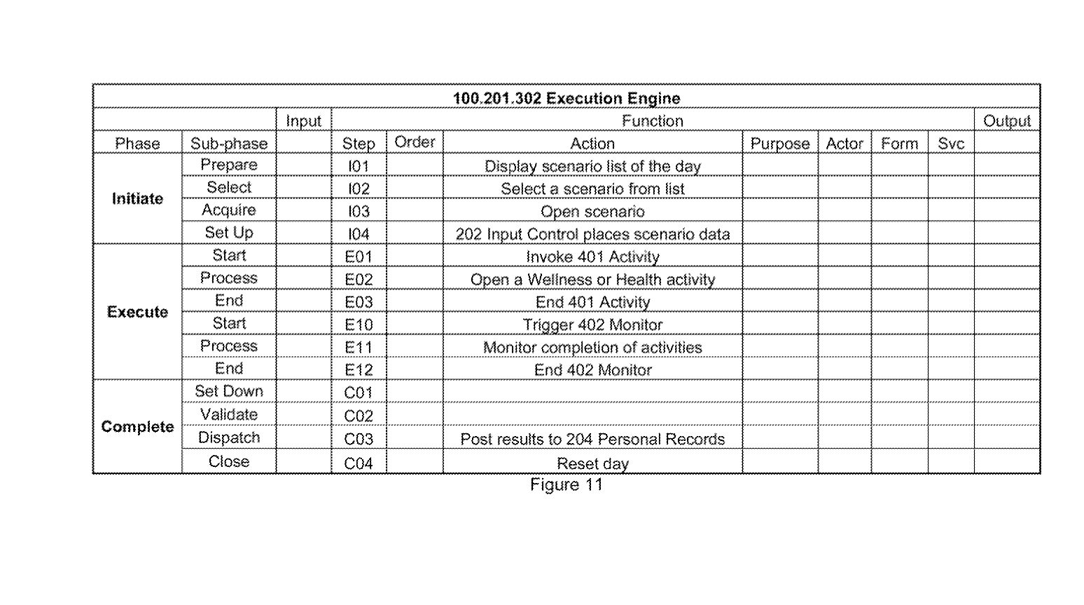

The 405 Build Engine, FIG. 10, allows the user to construct their chosen aspirations and chosen elements into daily scenarios. The Build Engine guides the user to create a name for scenario per the 501 Name Engine and then choose the aspiration and image that this scenario represents using the 502 Aspire Function. The Build Engine then guides the user to insert wellness and health elements into the daily scenario in sequence using the 503 Activities Engine according to the Initiate-Execute-Complete structure to enhance the potential success of the activity. The user can also insert the time of day that the activity should be accomplished by the 504 Time Engine. The Build Engine asks the user to assign the named scenario to the type of day—weekday, weekend, calendar date or special event with the 505 Day Function. This latter case can include an event of a moving date such as Thanksgiving, a periodic event such as renewing the tetanus shot or an episodic event such as retirement. Finally, the Build Engine allows the user to select a display using the 506 Device Engine such as a mobile device, a smart TV, a computer or even a print out. As the user completes each scenario, it is loaded into the 204 Personal Records storage.

201 Scenario Engine: 302 Execution Engine

Each day the 302 Execution Engine fetches the prepared scenarios for that type of day per FIG. 11 and presents them to the user's device. The user selects a scenario and the 302 Execution Engine fetches the scenario. The 202 Control Input Engine fetches updates to the scenario for named items. These updates are inserted into the designated process locations in the selected scenario and loaded onto the user's device displaying the name of the scenario, the aspiration and the image of the aspiration.

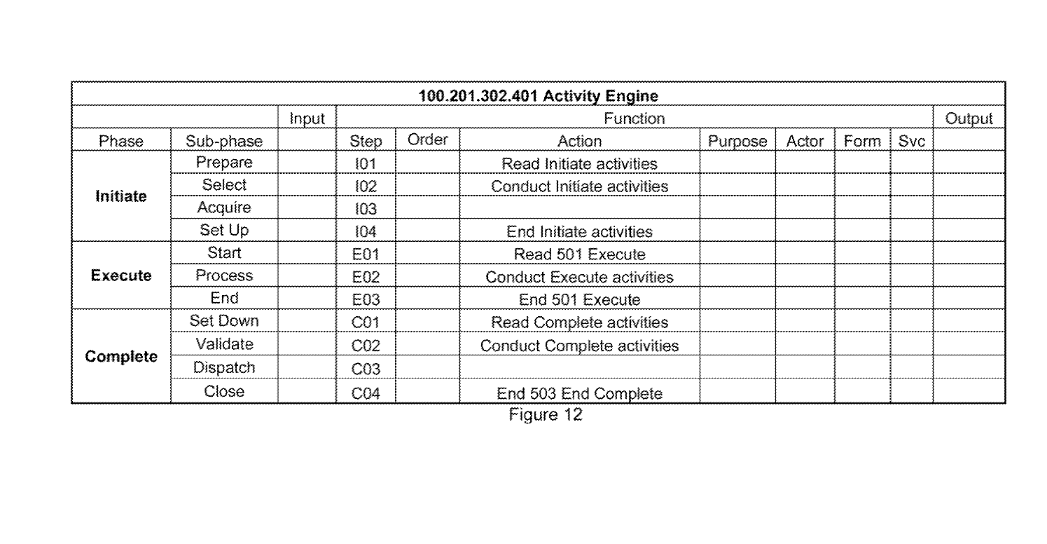

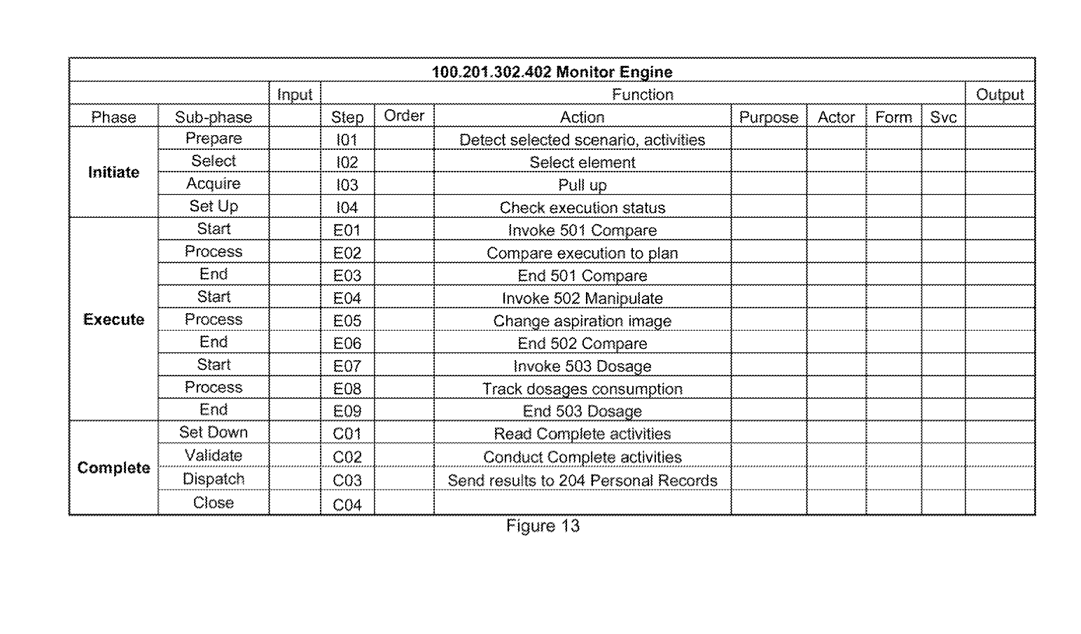

The user opens the scenario using the 401 Activity Engine per FIG. 12. The user views the chosen scenario, opens the wellness or health activity appropriate for that time, and enacts the Initiate, Execute and Complete steps included in the activity. As these steps are enacted, the actions can be captured either manually by the user or by a device and entered automatically, and the results are entered into the 204 Personal Records. As time passes in the user's day, the 402 Monitor Engine, FIG. 13, tracks the completion of the daily scenario and its activities using the 501 Compare Engine. If the user does not perform the activity within the planned time window, the 502 Manipulate Engine will distort the aspiration image on the user's device until the actions are complete.

The 503 Dosage Engine also checks dosage limits for exposures to radiation, medications or other elements over time. If for example, the user needs to have an x ray done, the user queries the 302 Execution Engine and checks the dosages to date against the cumulative total of dosages received to determine if another x ray is prudent. If the 204 Personal Records returns a positive result, the user can then safely have the x ray conducted. After the x ray is completed, a new count with dosage can be added to the personal record. If it is determined that various types of security scans or work related exposures affect health, these incidences can be accumulated as well.

The purpose of this formula is to create a job identifier that is both anonymous and has a high probability of being unique across the world. The 501.603 eight digit code is inserted first to discourage external users from sorting on location or date codes.

When the naming is complete, the 401 Naming Engine stores the information in respective locations. First, the unique identifier is placed in the 204 Personal Records storage. Second, the person's name and any designated devices for operating the Personal Lifecycle Engine will be place in a permanently separate 205 Personal Name storage and applies it to the identifier of the 100 Personal Lifecycle Engine. The reason for this is that if for any reason the personal records information is compromised, the hackers will have no access to the person's name or if they find the name, they have no access to the personal information. The only method for putting the name and the identifier together is for the 100 Personal Lifecycle Engine to call them under a valid operational scenario.

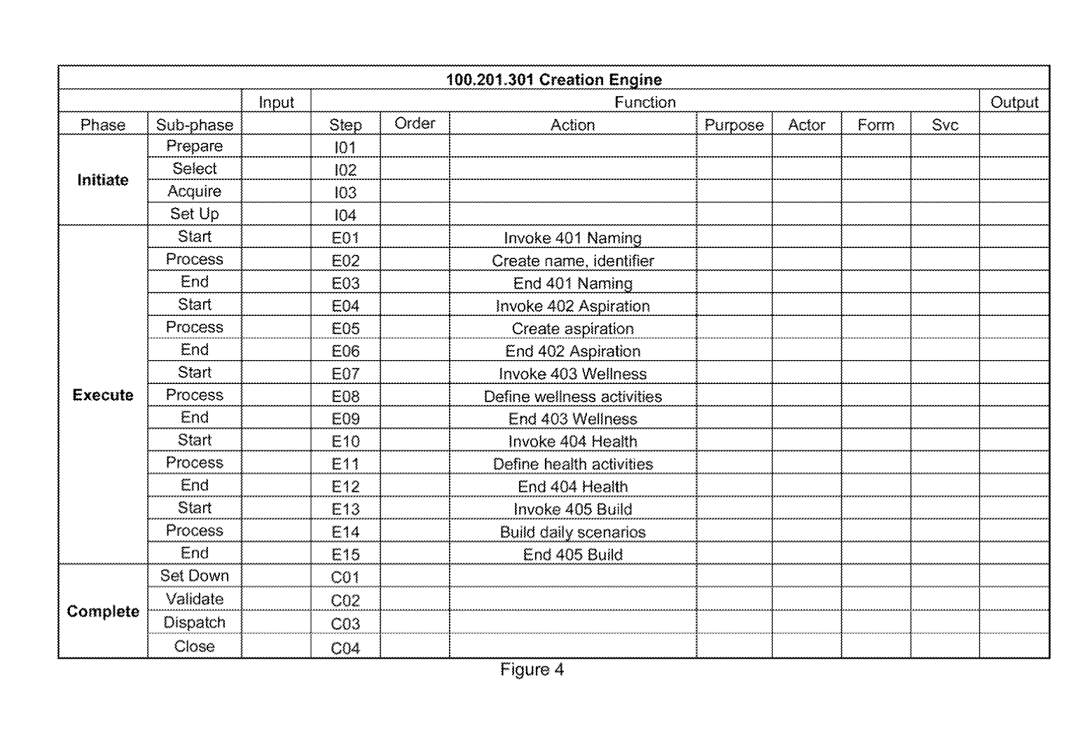

Only the user's Personal lifecycle engine can pull the name and records together since the 100 Personal Lifecycle Engine itself adopts the person's unique identifier. Using the 504 Attachment Engine, the identifier takes the place of the initial 100 designation of the Personal Lifecycle Engine making the person's engine unique in the world. All of the sub-ordinate operation numbers are concatenated in hierarchical order to the unique to build their scenarios—the 401 Naming, the 402 Aspiration, the 403 Wellness, the 404 Health and the 405 Build as shown in FIG. 4.

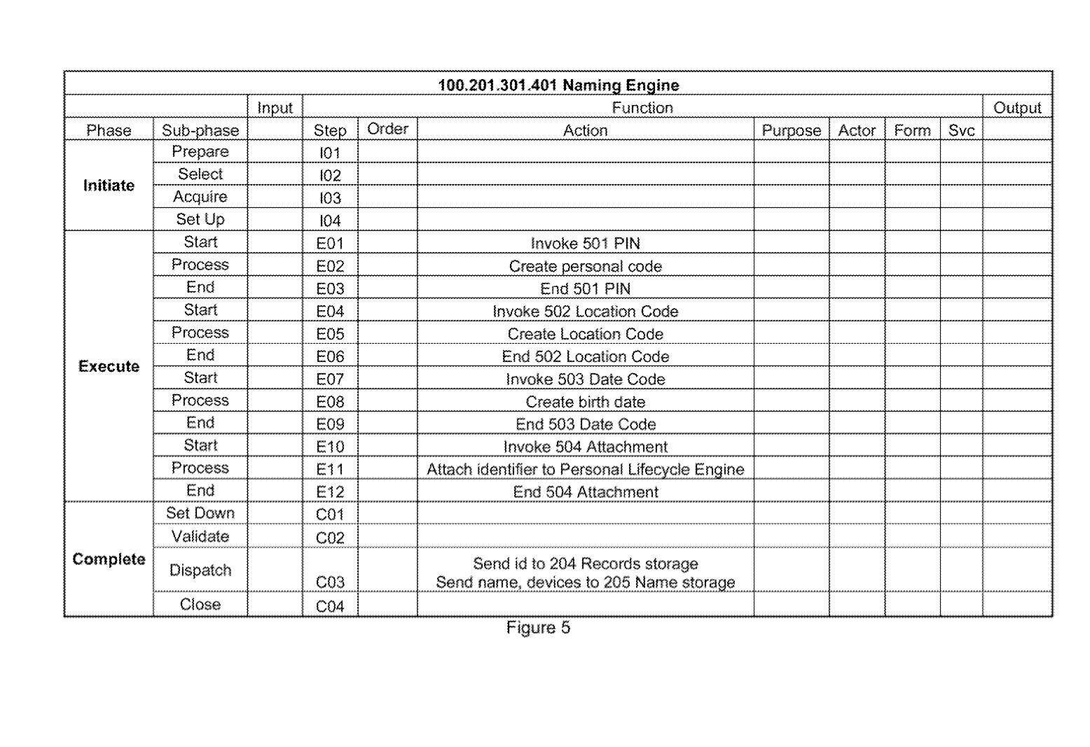

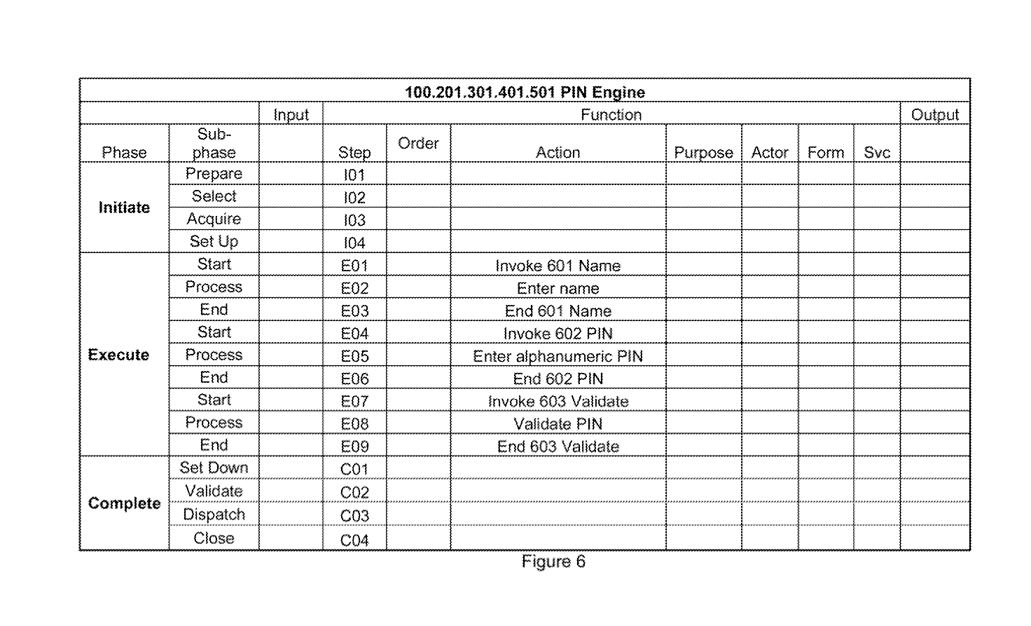

The first sub-engine of the 301 Creation Engine is the 401 Naming as shown in FIG. 4. The first time that users start their 100 Personal Lifecycle Engine, the Engine will direct them through the 301 Creation Engine to create an identifier using the 401 Naming Engine. The Naming Engine asks a user to create a unique identifier using the following formula per FIGS. 5 and 6:
501: a personal identification comprising:
   601: the person's name
   602 the person's devices; and
   603 an eight digit alphanumeric code,
502: a location of birth code that comprises:
   601: the person's name
   602: a three digit numeric country code,
   602: a two digit province/state code,
   603: a twelve digit town/city name; and
503: a date of birth code that comprises MMDDYYYY

The person's name is separated from the rest of the code so that the discrete elements are:
The person's name,
The unique identifier: alphanumeric code/location code/date code
   an override function to allow caregivers to solicit additional information. The 502 Emergency Engine can provide access processes for emergency staff to utilize in case the user is incapacitated. This allows for necessary information to be retrieved. Both the 501 Link Engine and the 502 Emergency Engine can provide specific process engine ids using the Ten-Level Enterprise Architecture to validate and allow the exchange of information.

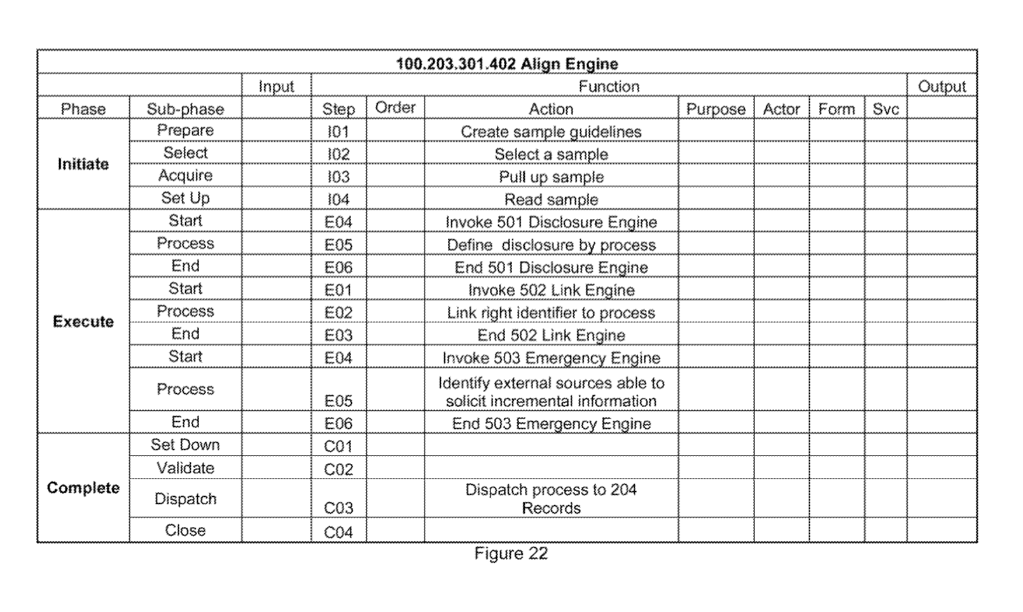

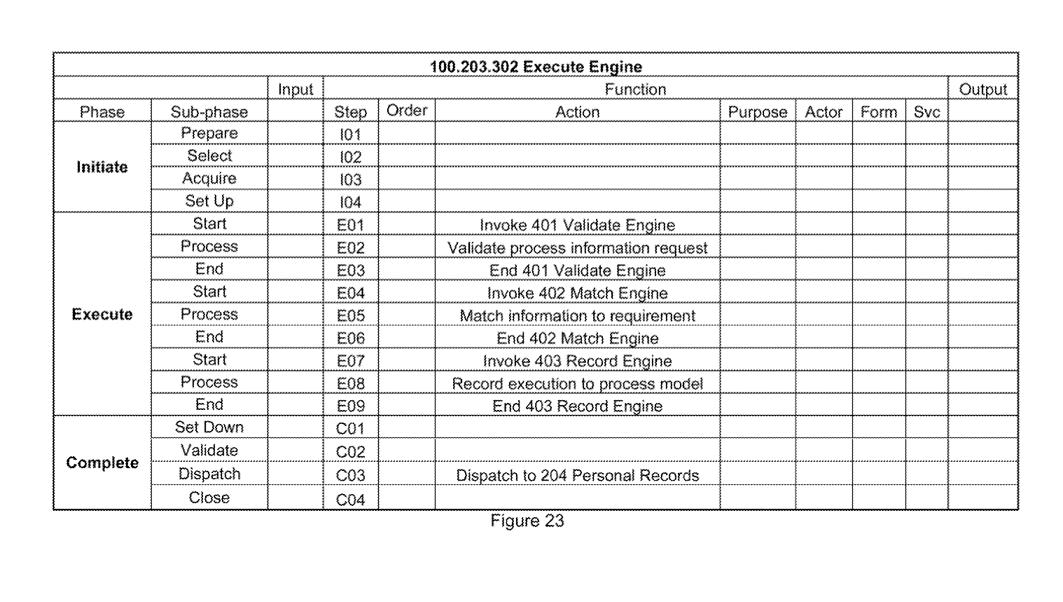

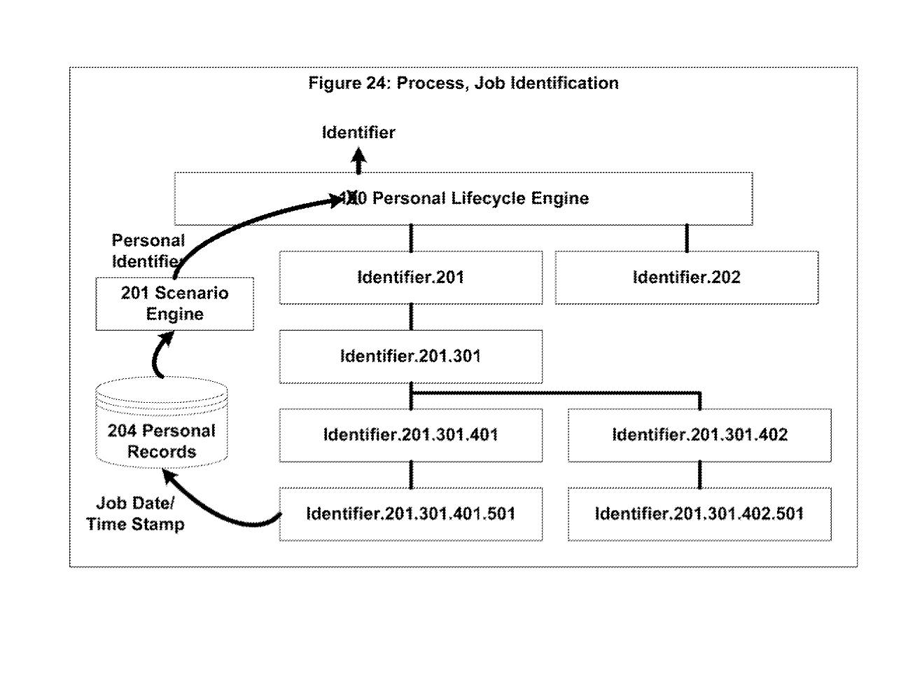

The 302 Execute Engine, FIG. 22, allows the user to execute the defined treatment processes. The 401 Validate Engine controls the process of validating the information request for the specific process segment while the 402 Match Engine aligns the required information and identification to the specific segment. The 403 Record Engine enables the user, the caregivers or the caregiver's systems to input the actual execution of the treatment processes manually or automatically into the user's Personal Lifecycle Engine. These processes are stored in the 204 Personal Records to become a permanent record of treatment.

What is claimed is:

1. A method of systematically performing personal health and wellness management, the method comprising:
performing a create operation, wherein the create operation comprises a naming operation, an aspiration operation, a wellness operation, a health operation, and a build-scenario operation; and
performing an execute operation, wherein the execute comprises a selection operation, an execute operation, and a monitor operation.

2. A method of claim 1, wherein the create operation comprises:
the naming operation comprises linking a unique identifier of the person and their devices;
the aspiration operation comprises a method for selecting a future personal aspiration for scenarios;
the wellness operation comprises a method for a person to select wellness elements for scenarios;
the health operation comprises a method for a person to select health elements for scenarios; and
the assignment operation assigns names and time periods to scenarios.

3. A method of claim 2, wherein the naming operation comprises:
the unique identifier method assigned to an individual that comprises
an eight digit alpha and numeric personal identification,
a location of birth code that comprises:
a three digit numeric country code,
a two digit province/state code,
a twelve digit town/city name;
a date of birth code that comprises MMDDYYYY;
the method of assigning the unique identifier to the user's Personal Lifecycle Engine; and
the concatenation of all sub-engine nomenclature to the assigned identifier.

4. A method of claim 2, wherein the aspiration operations comprises:
the method for assigning personal aspirations to future dates and/or ages; and
the method for assigning an image to each aspiration.

5. A method of claim 2, wherein the wellness operation comprises:
the selection method of religious rituals;
the selection method of family rituals;
the selection method of social rituals;
the selection method for emotional activity practices
the selection method of mental activity practices;
the selection method of rest practices; and
the method of pulling examples of each from external sources.

6. A method of claim 2, wherein the health operation comprises:
the selection method of diet practices and menus;
the selection method of physical activity practices;
the selection method of medication needs;
the selection methods of treatment needs and
the method of pulling examples of each from external sources.

7. A method of claim 2, wherein the build-scenario operation comprises:
the method for providing a name for the scenario;
the method for assigning the aspiration and image to the scenario;
the method for defining the day by type, calendar or event;
the method for sequencing wellness and health activities within the day; and
the method for assigning the display medium for the scenario.

8. A method of claim 1, wherein the scenario operation comprises:
the selection operation comprises a method for a person to select a scenario for a day;
the execution operation comprises a method for a person to execute a scenario in a initiate-execute-complete process structure; and
the monitor operation comprises a method for a person to monitor their progress in achieving the scenario.

9. A method of claim 8, wherein the selection operation comprises:
the display operation comprises a method for presenting the scenarios associated with that type of day;
the select operation comprises a method for selecting a scenario to execute that day;
the set timer operation comprises a method for triggering a timer for the scenario activities; and
the fetch operation that pulls the latest wellness and help elements from external sources.

10. A method of claim 8, wherein the execute operation comprises:
the activity operation comprises a method for showing the activities and their contents of the scenario; and
the input operation comprises a method for the person for input activities accomplished.

11. A method of claim 8, wherein the monitor operation comprises:
the remainder operation comprises a method for showing the remaining activities and time in the scenario;
the aspiration manipulation operation comprises a method for manipulating the aspiration image based on the level of scenario achievement over time;
the exposure operation comprises a method for calculating the accumulated exposure to medications, radiation or other elements over time compared to safe limits; and
a store operation comprises the storage of scenarios and results in a database.

12. A method of systematically performing the controlled input into personal scenarios, the method comprising:
the element operation comprises a method of normalizing the input of elements; and
the scenario operation comprises a method of normalizing the input of processes.

13. A method of claim 12 systematically performing the controlled input of elements—data, information, rules and specifications, the method comprising:
the input operation comprises a method for establishing common naming of elements to be used;
the input operation comprises a method for translating various names into the common naming convention;
the input operation comprises a method for establishing common units of measurement of elements to be used;
the input operation comprises a method for translated various measurements into the common measurement convention;
the input operation comprises a method for searching in external sources for instances of the named elements; and
the input operation comprises a method to insert instances of the discovered elements into specified locations of the scenarios.

14. A method claim 12 of systematically performing the controlled input of processes, the method comprising:
the creation operation comprises a method for defining various care treatment templates in an initiate-execute-complete process structure;
the execute operation comprises a method for capturing actual care treatment processes into the templates; and
the process operation comprises a method for capturing execution elements—persons, dosages and materials—used in the treatment process.

15. A method of systematically performing the controlled output of the personal scenario, the method comprising:
the control set up operation comprises a method for defining the controlled dissemination of personal information; and
the control execute operation comprises a method for dissemination of personal information.

16. A method of claim 15, wherein the control set up operation comprises:
the attachment operation comprises a method to link the unique personal identifier to a user's job;
the storage operation comprises a method to store the user's name in a separate database from the user's unique personal identifier and personal data;
the treatment operation comprises definitions of types of treatments with the required information disclosure needs; and
the identification operation comprises a method to match the personal data, name, or unique personal identifier allowed to be sent to external job ids:
the usage id of job id,
the user id of the job id, and
the named personal content to be disclosed by job id.

17. A method of claim 15, wherein the control-execute operation comprises:
the validation operation comprises a method to identify the job id, the usage id and the user id;
the dispatch operation comprises a method to match and dispatch the named data against the validated request; and
the record operation comprises a method to record dispatch of the data against a specific job id.

18. A method to uniquely identifying every process in the Personal Lifecycle Engine, the method comprising:
the method of creating a sequential job id;
the attachment of the engine concatenated id; and
the attachment of a date/time stamp.
